(19) United States
(12) Patent Application Publication
(10) Pub. No.: US 2008/0130438 A1
(43) Pub. Date: Jun. 5, 2008

(54) OPTICAL DISK APPARATUS AND CONTROL METHOD THEREFOR

(75) Inventors: Takahiko Mihara, Tokyo (JP); Hiroaki Morino, Tokyo (JP); Yuichi Ito, Tokyo (JP); Yukiyasu Tatsuzawa, Tokyo (JP); Toshihiko Kaneshige, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/771,863

(22) Filed: Jun. 29, 2007

(30) Foreign Application Priority Data
Jun. 29, 2006 (JP) 179251/2006

(51) Int. Cl. G11B 5/09

(52) U.S. Cl. 369/47.36

(57) ABSTRACT

An optical disk apparatus for recording data on and reproducing data from a recordable optical disk includes a storage unit and a control unit. The storage unit is configured to store specific useful information necessary for at least one of recording data on and reproducing data from the optical disk. The control unit is configured to record the useful information stored in the storage unit in a test write area of the optical disk, and reproduce and use the recorded useful information when the optical disk is placed in the optical disk apparatus.

### CROSS-REFERENCE TO RELATED APPLICATIONS

This application claims the benefit of priority of Japanese Patent Application No. 2006-179251, filed Jun. 29, 2006, the entire contents of which are incorporated herein by reference.

### BACKGROUND OF THE INVENTION

1. Field

The present invention relates to optical disk apparatuses and control methods therefor, and particularly relates to a recording/reproducing optical disk apparatus and control method therefor.

2. Description of the Related Art

Recordable optical disks, such as CD-Rs, DVD-Rs, and DVD-RAMs are now widely used.

Information is recorded on such a recordable optical disk using a laser beam focused on a recording surface of the disk. Optimum laser power for recording often varies from one optical disk to another, as well as depending on the type of optical disk, because of differences in their material and shape.

Therefore, before the start of information recording on an optical disk of this type, test write is performed on a power calibration area (PCA) in a specified location on the optical disk. On the basis of the result of such test write, optimum recording laser power for each disk is learned and determined.

However, since the adjustment of laser power based on the result of test write requires a relatively long period of time, reducing the time required for such adjustment becomes an issue to be addressed.

For example, JP-B 3450821 discloses a technique in which an optical disk has a plurality of test zones on which test write is performed and a plurality of power setting information zones associated with the respective test zones. Examples of information recorded in each power setting information zone include optimum power information obtained by reproducing data recorded in a test zone, location information indicating the location of the test zone, and device identification information of a recording apparatus (or disk drive). To record data on the optical disk after such information is recorded in a predetermined area, the recording apparatus reads device identification information from a power setting information zone. If read device identification information matches device identification information of its own, the recording apparatus sets recording laser power on the basis of optimum power information which has been read along with the device identification information, thereby reducing learning time.

With the technique disclosed in JP-B 3450821, if a recording apparatus which previously performed test write and a recording apparatus which is currently trying to perform recording are one and the same apparatus, it may be possible to reduce learning time required for determining optimum power information.

However, in the technique disclosed in JP-B 3450821, test zones in which data for test write is to be recorded and power setting information zones associated with the respective test zones need to be provided on an optical disk in pairs. This means that each test write involves two zones. Therefore, further improvement is needed to achieve effective use of a PCA on the optical disk.

Additionally, even with the technique disclosed in JP-B 3450821, if a recording apparatus which is currently trying to perform recording does not match any recording apparatuses which previously performed test write, it is necessary to sequentially secure new test zones and their corresponding power setting information zones. If the area of these zones increases and it becomes impossible to secure new test zones in a predetermined PCA, no further test write can be performed. As a result, even if there is still room in a user data recording area, it is not possible to record information on the optical disk. This is a serious problem particularly for an optical disk (e.g., CD-R or DVD-R) which is recordable only once, because even data in a PCA cannot be overwritten.

In this respect, again, it is desired that the number of zones required for each test write be minimized and that effective use of a PCA be achieved.

### SUMMARY OF THE INVENTION

The present invention has been made in view of the circumstances described above, and provides an optical disk apparatus and control method therefor that allow a recording/reproducing optical disk apparatus not only to reduce learning time required for determining optimum recording laser power and the like, but also to achieve effective use of a PCA on which to perform test write.

According to an aspect of the present invention, an optical disk apparatus for recording data on and reproducing data from a recordable optical disk includes a storage unit configured to store specific useful information necessary for at least one of recording data on and reproducing data from the optical disk; and a control unit configured to record the useful information stored in the storage unit in a test write area of the optical disk, and reproduce and use the recorded useful information when the optical disk is placed in the optical disk apparatus.

According to another aspect of the present invention, a control method for an optical disk apparatus for recording data on and reproducing data from a recordable optical disk includes the steps of storing specific useful information necessary for at least one of recording data on and reproducing data from the optical disk; recording the stored useful information in a test write area of the optical disk; and reproducing and using the recorded useful information when the optical disk is placed in the optical disk apparatus.

With the optical disk apparatus and control method therefor according to the present invention, it is possible for a recording/reproducing optical disk apparatus not only to reduce learning time required for determining optimum recording laser power and the like, but also to achieve effective use of a PCA on which to perform test write.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating an exemplary configuration of an optical disk apparatus according to an embodiment of the present invention.

FIGS. 2A to 2C illustrate a concept of a recording strategy.

FIG. 3 is a flowchart illustrating an exemplary process of recording data in a test zone.

FIG. 4 illustrates an exemplary configuration of a recording area of an optical disk.

FIG. 5 illustrates exemplary data items to be recorded in a test zone.

FIG. 6 illustrates exemplary values set in a table when the type of write learning process is a laser-power write learning process.

FIG. 7 is a flowchart illustrating a method of using data recorded in a test zone.

FIG. 8 is a flowchart illustrating an exemplary process for recording BCA data in a test zone.

FIG. 9 is a flowchart illustrating an exemplary process for reading BCA data recorded in a test zone.

### DETAILED DESCRIPTION

An optical disk apparatus and control method therefor according to an embodiment of the present invention will now be described with reference to the attached drawings.

### (1) Configuration and Basic Recording/Reproducing Operation of Optical Disk Apparatus

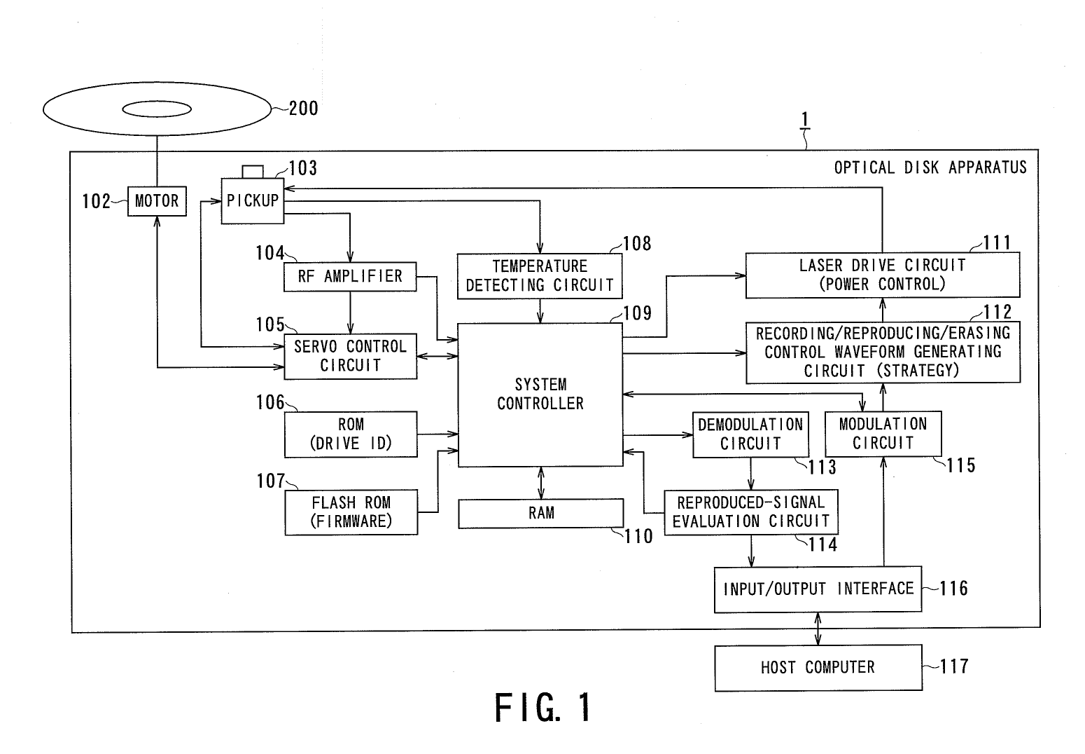

FIG. 1 is a block diagram illustrating an exemplary configuration of an optical disk apparatus 1 according to an embodiment of the present invention.

The optical disk apparatus 1 is an apparatus capable of reproducing data from and recording data on a readable/writable optical disk 200, such as a CD-R, DVD-R, DVD-RAM, HD DVD-R, or HD DVD-RAM.

The optical disk apparatus 1 includes a motor 102, pickup 103, RF amplifier 104, servo control circuit 105, ROM 106, flash ROM 107, temperature detecting circuit 108, system controller (or control unit) 109, RAM (or storage unit) 110, laser drive circuit 111, recording/reproducing/erasing control waveform generating circuit 112, demodulation circuit 113, reproduced-signal evaluation circuit 114, modulation circuit 115, and input/output interface 116.

An overview of a basic operation of the optical disk apparatus 1 configured as described above will now be described. First, a recording operation will be described.

The optical disk apparatus 1 is connected to a host computer 117, such as a personal computer. For data recording, write data (which is data to be recorded) is transmitted from the host computer 117 along with a recording command.

The write data is input through the input/output interface 116 to the modulation circuit 115. The modulation circuit 115 modulates the write data into a recording code. For example, if the optical disk 200 is a conventional DVD, the write data is modulated in an 8/16 modulation scheme, while if the optical disk 200 is an HD DVD, the write data is modulated in an 8/12 modulation scheme.

The modulated write data is input to the recording/reproducing/erasing control waveform generating circuit 112, which generates a laser pulse waveform for each of recoding, reproducing, and erasing modes.

Specifically, for data recording, a laser pulse waveform for achieving an optimum pit shape on the surface of the optical disk 200 is generated on the basis of a recording strategy set by the system controller 109.

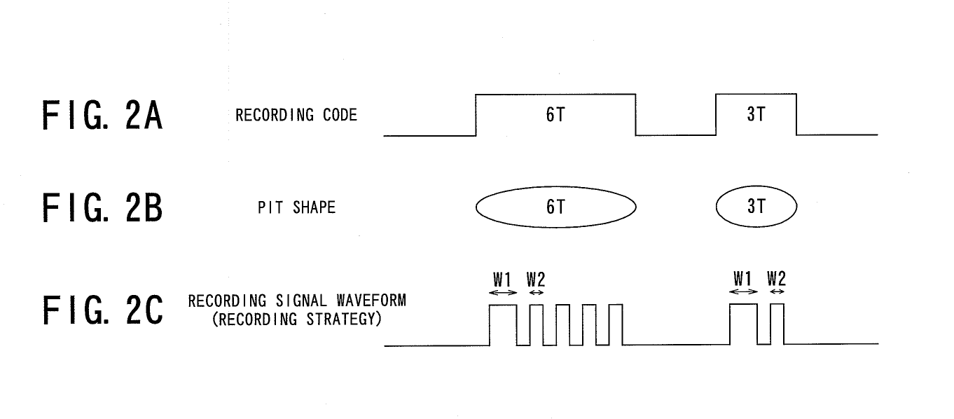

FIGS. 2A to 2C illustrate a concept of the recording strategy. The write data can be classified as “6T” (e.g., six bits of data containing sequential “1”s) or “3T” (e.g., three bits of data containing sequential “1”s) (see FIG. 2A). For example, when “6T” data is to be recorded on the optical disk 200, a good pit shape cannot necessarily be achieved by simply irradiating the optical disk 200 with a laser pulse with a pulse width of “6T”. In practice, a good pit shape as illustrated in FIG. 2B is achieved by irradiating the optical disk 200 with a pulse train of a plurality of pulses (as illustrated in FIG. 2C) produced by dividing a single laser pulse.

Factors involved in a pulse waveform for achieving an optimum pit shape (e.g., the number of pulses and the pulse width of each pulse) vary depending not only on the type of code, such as “6T” or “3T”, but also on the type and material of the optical disk 200 on which data is to be recorded.

Therefore, the optical disk apparatus 1 is typically configured to have information about a plurality of factors involved in a pulse waveform, and to select or set pulse factors for achieving an optimum pit shape. A method for selecting or setting such pulse factors is referred to as a recording strategy. Factors involved in a pulse waveform are often also referred to as a recording strategy.

A recording strategy is selected and set by the system controller 109. On the basis of this recording strategy, the recording/reproducing/erasing control waveform generating circuit 112 generates a laser pulse waveform and outputs the generated laser pulse waveform to the laser drive circuit 111.

The laser drive circuit 111 adjusts the laser power of a laser oscillator included in the pickup 103. Again, to achieve an optimum pit shape, it is very important to adjust recording laser power for data recording.

After the adjustment of laser power, the resulting laser pulse waveform for laser drive is input to the pickup 103. Then, the corresponding laser beam is applied to the recording surface of the optical disk 200 and forms pits thereon.

On the other hand, for data reproduction, a laser beam having laser power for data reproduction is applied to the optical disk 200. Then, light reflected off the optical disk 200 is converted by the pickup 103 into an RF signal. The RF signal is adjusted by the RF amplifier 104 to an appropriate level and input to the demodulation circuit 113. In the demodulation circuit 113, the RF signal is converted into digital data, which is then code-demodulated.

The reproduced-signal evaluation circuit 114 performs error correction on reproduced data having been code-demodulated in the demodulation circuit 113. The reproduced-signal evaluation circuit 114 also performs a quality evaluation on a reproduced signal. For example, the reproduced-signal evaluation circuit 114 performs a jitter evaluation or error rate evaluation on the RF signal.

The reproduced data subjected to error correction is output through the input/output interface 116 to the host computer 117.

On the basis of an error signal, such as a tracking error signal, output from the pickup 103, the servo control circuit 105 controls the position and attitude of the pickup 103, the speed of the motor 102 for rotating the optical disk 200, and the like.

The ROM 106 stores data, such as device identification information of the optical disk apparatus 1 itself. The flash ROM 107 stores firmware executed by a processor (not shown) of the system controller 109.

The RAM 110 temporarily stores, as necessary, various types of data processed by the processor.

### (2) Control Method for Optical Disk Apparatus (Write Learning Process of First Embodiment)

As described above, an optimum recording strategy varies depending on the type and material of the optical disk 200. This also applies to recording laser power. That is, the optimum level of recording laser power also varies depending on the type and material of the optical disk 200. Moreover, even among optical disks of basically the same type and material, there may be variations in optimum recording strategy and optimum recording laser power, because there will be individual differences resulting from differences in production lot, and characteristics of these optical disks will change with time.

Therefore, before recording actual data in a user area, the optical disk apparatus 1 normally performs test write to determine optimum recording laser power and optimum recording strategy (hereinafter, recording laser power and recording strategy will be collectively referred to as “recording parameter”) every time recording is performed. This procedure performed by the optical disk apparatus 1 is referred to as “write learning process”.

Test write is performed on a predetermined test write area called PCA. For example, test write is performed using different levels of recording laser power produced by varying an initial value in predetermined steps, or using different recording strategies that are slightly different from one another.

The test write is performed using different recording parameters on a plurality of sub-areas created by dividing the test write area.

The optical disk apparatus 1 immediately reproduces data recorded in the test write area, evaluates the resulting reproduced signals on the basis of predetermined evaluation criteria, and determines an optimum recording parameter. For example, if the amount of jitter of a reproduced signal is equal to or less than a predetermined threshold value and is smallest, a recording parameter corresponding to this reproduced signal is determined to be an optimum recording parameter. Thus, the subsequent recording of actual data in the user area is performed using this optimum recording parameter.

Conventionally, data recorded in a test write area is meaningless data, such as random data.

Therefore, when a write learning process is completed and an optimum recording parameter is determined, the test write area in which such meaningless data is recorded is left as it is as a useless area.

An aspect of the present invention is to record data having specific meanings (i.e., useful information) in a test write area in test write, thereby making effective use of the test write area. Hereinafter, a write learning method of the first embodiment will be described.

A write learning process includes a recording phase in which the optical disk apparatus 1 records data in a test write area (hereinafter also referred to as “test zone”) and a using phase in which the optical disk apparatus 1 uses the recorded data.

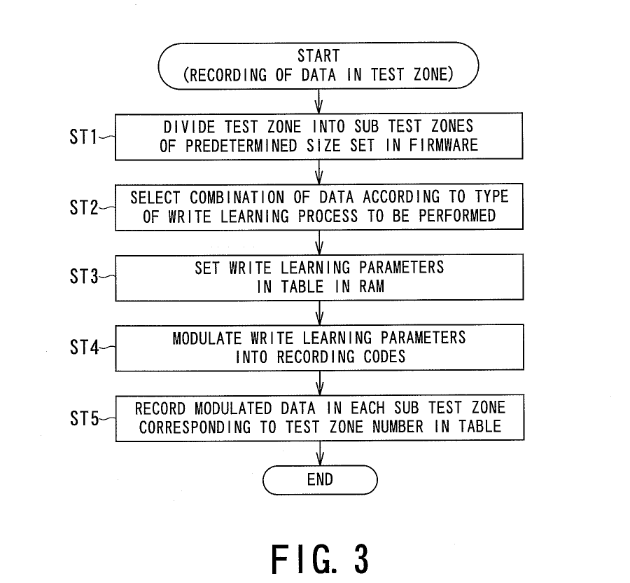

FIG. 3 is a flowchart illustrating an exemplary process of recording data in a test zone.

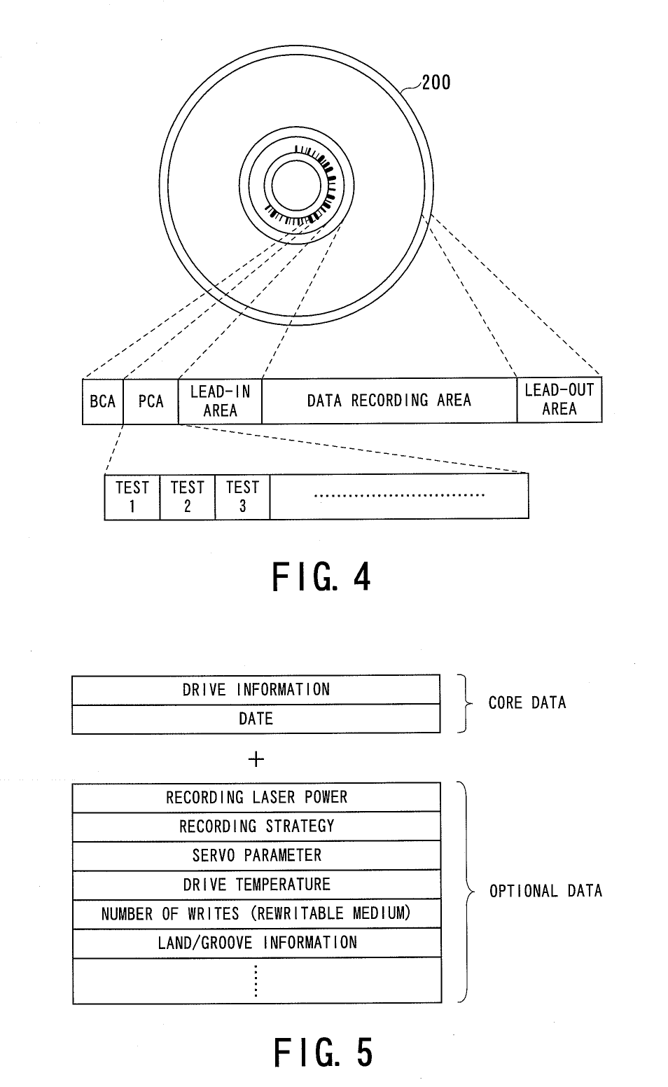

First, in step ST1, a test zone is divided into sub test zones. FIG. 4 illustrates an exemplary configuration of a recording area of the optical disk 200. The recording area of the optical disk 200 is divided, from the inside, into a burst cutting area (BCA), PCA, lead-in area, data recording area, and lead-out area. The test zone corresponds to the PCA of the recording area. That is, in step ST1, the PCA is divided into sub-areas (or sub test zones), each having a predetermined size. The sub test zones are assigned test zone numbers, such as “TEST 1”, “TEST 2”, and so on.

A write learning process is performed when the processor of the system controller 109 executes the firmware stored in the flash ROM 107. The type and amount of data to be recorded in the test zone vary depending on the type of write learning process. Therefore, the test zone is divided into sub test zones of predetermined size set by firmware.

Next, in step ST2, a combination of data items and data to be recorded in the test zone are selected according to the type of write learning process to be performed.

FIG. 5 illustrates exemplary data items to be recorded in the test zone. Of these data items, “drive information” (device identification information of the optical disk apparatus 1 which records data in the test zone) and “date” (date of recording) are core data items that are always recorded regardless of the type of write learning process.

Other data items, including “recording laser power” and others that follow, are optional data items from which some are selected and combined according to the type of write learning process.

Examples of the type of write learning process include a laser-power write learning process for determining optimum recording laser power and a strategy write learning process for determining an optimum recording strategy. To perform the laser-power write learning process, “recording laser power” of FIG. 5 is selected (i.e., “recording strategy” is not selected). For example, if “recording laser power” is selected, an initial value “Z” of the recording laser power and an incremental step “α” are set.

Other data items include “servo parameter” such as a radial tilt angle, “drive temperature” detected by the temperature detecting circuit 108, the “number of writes” to the optical disk 200 (selected when the optical disk 200 is a rewritable optical disk), and “land/groove information” indicating whether data is to be recorded on either lands or grooves. Some of these data items are selected and values (or parameters) for the selected data items are set as additional conditions for recording data in the test zone.

Next, values for the selected data items are set, in the RAM 110, in the form of a table (step ST3).

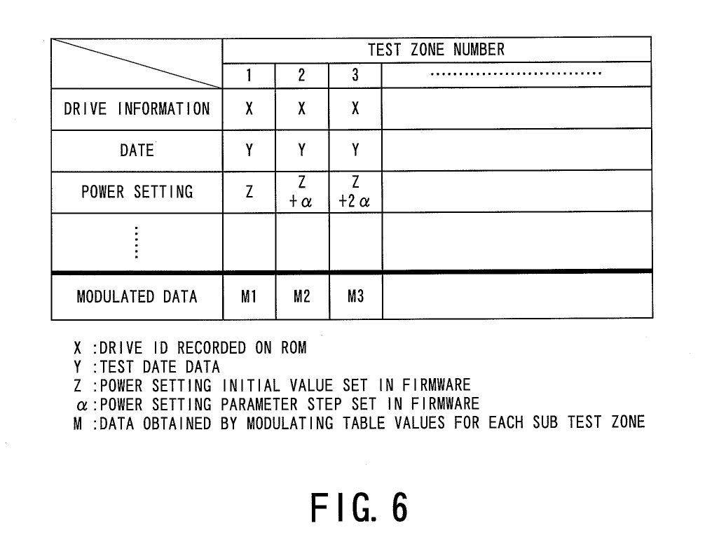

FIG. 6 illustrates exemplary values set in a table when the type of write learning process is a laser-power write learning process.

Test zone numbers “1”, “2”, and so on (FIG. 6) correspond to “TEST 1”, “TEST 2”, and so on (FIG. 4), respectively. In the table of FIG. 6, “drive information” field and “date” field for each sub test zone always contain the same values (or data), such as “X” and “Y”, set in step ST2.

On the other hand, “power setting” field contains different values of laser power necessary for a laser-power write learning process. Specifically, an initial value “Z” is set for sub test zone 1, and different laser power values obtained by incrementing the initial value “Z” in steps of “α” are set for sub test zone 2 and other sub test zones that follow. Other fields under “power setting” field contain values for data items selected, as additional conditions and the like, in step S2.

Next, data (or values) for each sub test zone is code-modulated by the modulation circuit 115 (step ST4). The table of FIG. 6 also shows modulated data (M1, M2, and so on) obtained by code modulation.

In step ST5, a plurality of pieces of modulated data are sequentially recorded in sub test zones of the optical disk 200 corresponding to respective test zone numbers in the table of FIG. 6. Here, for the laser drive circuit 111, the system controller 109 sets recording laser power values contained in “power setting” field of the table. In other words, when test write is performed, recording laser power data to be recorded in a sub test zone matches the power of a laser beam with which the data is to be recorded in the sub test zone.

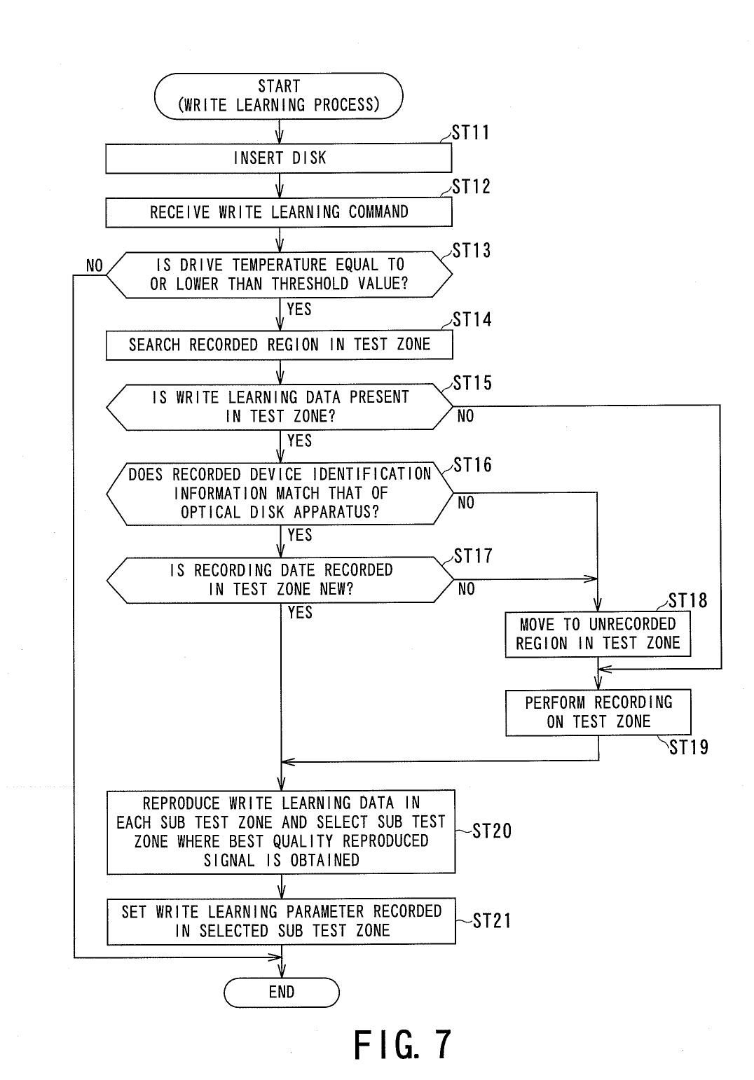

A method of using data recorded in the test zone will now be described with reference to a flowchart of FIG. 7.

In step ST11, the optical disk 200 is inserted into the optical disk apparatus 1. This optical disk 200 may be one with a test zone on which test write was performed by another optical disk apparatus 1 according to the procedure described above.

For data recording, a recording command as well as data to be recorded is transmitted from the host computer 117 to the optical disk apparatus 1. Together with the recording command, a write learning command for instructing a write learning process to be performed is normally transmitted to the optical disk apparatus 1.

Upon receipt of the write learning command (step ST12), the optical disk apparatus 1 monitors a drive temperature detected by the temperature detecting circuit 108. If the drive temperature is higher than a predetermined threshold value (NO in step ST13), the process is terminated because a normal recording operation cannot be guaranteed. In this case, appropriate alarm information may be provided to the user.

If the drive temperature is equal to or lower than a predetermined threshold value (YES in step ST13), the process proceeds to step ST14, where the optical disk apparatus 1 searches a recorded region in the PCA (test zone).

If no write learning data is present in the test zone (NO in step ST15), the process proceeds to step ST19, where a recording process is performed on the test zone. More specifically, steps ST1 to ST5 of FIG. 3 are performed in step ST19.

On the other hand, if write learning data is present in the test zone (YES in step ST15), the process proceeds to step ST16, where it is determined whether device identification information (drive ID) recorded in the test zone is the same as that of the optical disk apparatus 1.

If device identification information recorded in the test zone matches that of the optical disk apparatus 1 (YES in step ST16), the process proceeds to step ST17, where it is determined whether the date of recording (“date”) recorded in the test zone is relatively new. For example, it is determined whether recording was performed on the test zone not more than a year ago.

If device identification information recorded in the test zone does not match that of the optical disk apparatus 1 (NO in step ST16), the optical disk apparatus 1 which performed recording on the test zone is not one and the same as the optical disk apparatus 1 in which the optical disk 200 is currently placed. Generally, optimum recording laser power is consistent if the optical disk 200 and the optical disk apparatus 1 which performed test write thereon are the same as the optical disk 200 and the optical disk apparatus 1 in which the optical disk 200 is currently placed, respectively. However, if either one of the optical disk 200 or the optical disk apparatus 1 is different, it cannot be guaranteed that optimum laser power is consistent.

Moreover, even if the optical disk 200 is one and the same, characteristics of its materials or the like can change over a long period of time, which may cause optimum recording laser power to change.

Therefore, if negative determinations are made in steps ST16 and ST17 (NO in steps ST16 and ST17), focus is moved to an unrecorded region in the test zone (step ST18) and test write is performed on this unrecorded region (step ST19).

If positive determinations are made in steps ST16 and ST17 (YES in steps ST16 and ST17), it can be guaranteed that optimum laser power remains valid.

Therefore, test write data previously recorded can be used, and there is no need to perform another test write.

In step ST20, data in each sub test zone is reproduced, and a sub test zone where a reproduced signal of the best quality is obtained is selected. The quality of reproduced signal is determined on the basis of the jitter of RF signal, error rate of reproduced data, or the like. If the jitter of RF signal is used, the determination of quality of reproduced signal and the selection of a sub test zone can be made in a relatively short period of time.

After the selection of a sub test zone, recording laser power data recorded in the selected sub test zone is extracted as optimum laser power and set in the laser drive circuit 111 (step ST21).

After the series of steps described above, the optical disk apparatus 1 uses this recording laser power to record write data output from the host computer 117 in the data recording area of the optical disk 200.

While a laser-power write learning process has been primarily described, a strategy write learning process can be performed by following a similar procedure to that described above.

In the write learning method of the first embodiment, once the optical disk apparatus 1 has performed test write on the test zone of the optical disk 200, no further test write is required if the same optical disk apparatus 1 performs recording on the same optical disk 200. This can make write learning time shorter than before.

In the write learning method of the first embodiment, device identification information and information having specific meanings (i.e., useful information), such as recording parameters, are recorded in the test zone.

Therefore, unlike in the case of the technique disclosed in JP-B 3450821, it is not necessary that test zones in which test write data (e.g., random data) is recorded and power setting information zones associated with the respective test zones be provided in pairs. Therefore, effective use of a test zone on the optical disk can be achieved.

### (3) Control Method for Optical Disk Apparatus (Write learning Process of Second Embodiment)

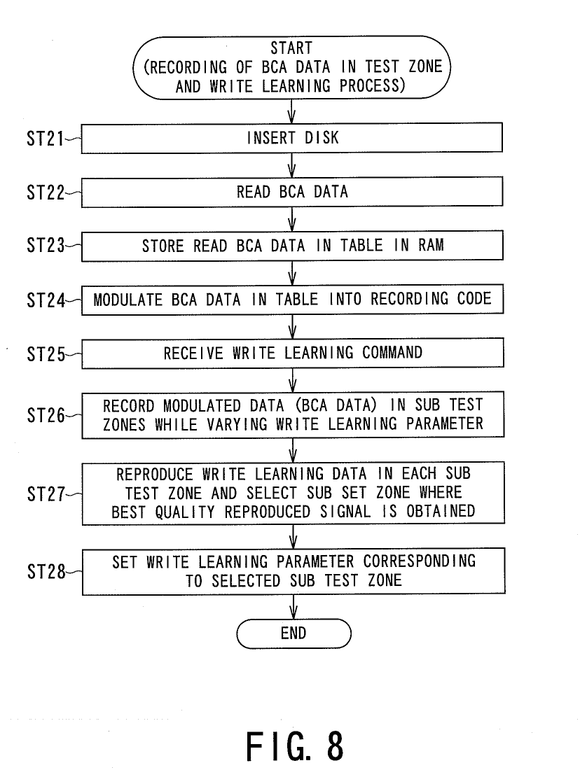

Data used to perform test write on the test zone may be useful information other than recording parameters. In a write learning process according to a second embodiment of the present invention, BCA data is recorded in the test zone. FIG. 8 is a flowchart illustrating a process of recording BCA data in the test zone.

When the optical disk 200 is inserted into the optical disk apparatus 1 (step ST21), the optical disk apparatus 1 first reads BCA data recorded in the BCA (step ST22). As illustrated in FIG. 4, the BCA is an area provided in the innermost part of the optical disk 200 and in which BCA data is recorded in the form of a barcode, unlike in the case of other areas. For example, information about copyright protection is recorded as BCA data in the BCA.

The read BCA data is stored in the RAM 110 (step ST23). This BCA data is modulated by the modulation circuit 115 into a recording code, which is also stored in the RAM 110 (step ST24).

As described in the first embodiment, when data is to be recorded on the optical disk 200, the host computer 117 transmits a write learning command to the optical disk apparatus 1.

Upon receipt of the write learning command (step ST25), the optical disk apparatus 1 records, in a plurality of sub test zones obtained by dividing the test zone of the optical disk 200, modulated data (BCA data) stored in the RAM 110 while varying a recording parameter, such as the level of recording laser power (step ST26). At the same time, recording laser power values are associated with respective test zone numbers (which are assigned to the sub test zones) and stored. In the second embodiment, the same BCA data is stored in the plurality of sub test zones with different levels of laser power.

After recording the BCA data in the sub test zones, the optical disk apparatus 1 immediately reproduces data in each sub test zone and selects a sub test zone where a reproduced signal of the best quality is obtained. For example, the optical disk apparatus 1 selects a sub test zone where a reproduced signal with the smallest jitter which is lower than a predetermined threshold value is obtained (step ST27).

Last, the optical disk apparatus 1 sets, in the laser drive circuit 111, a recording laser power value associated with a test zone number corresponding to the selected sub test zone. After the series of steps described above, the optical disk apparatus 1 uses this recording laser power to record write data output from the host computer 117 in the data recording area of the optical disk 200.

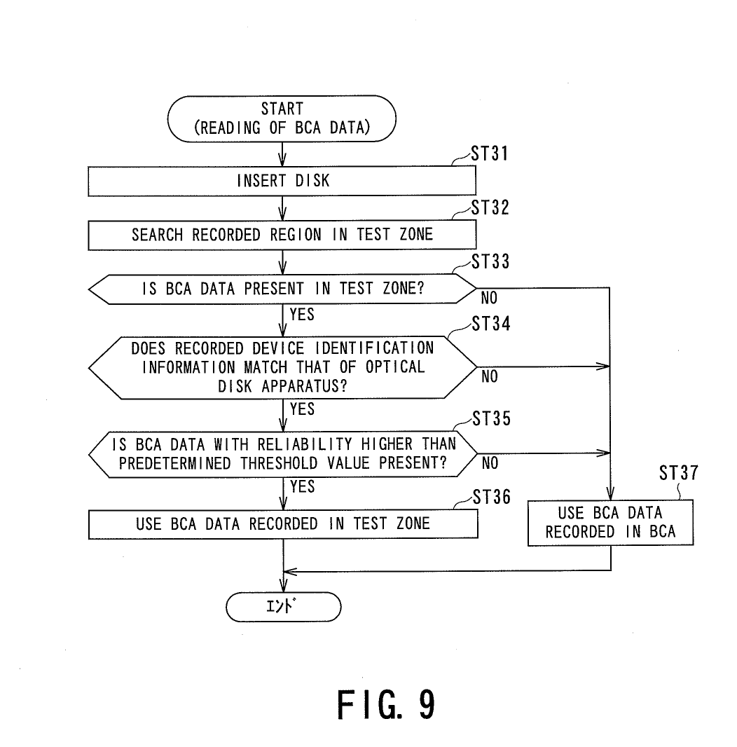

Next, a method of using BCA data recorded in the test zone will be described. FIG. 9 is a flowchart illustrating an exemplary process for reading BCA data recorded in the test zone.

When the optical disk 200 is inserted (step ST31), the optical disk apparatus 1 searches a recorded region in the test zone (step ST32) and determines whether BCA data is recoded in the test zone (step ST33).

If BCA data is recoded in the test zone (YES in step ST33), the optical disk apparatus 1 further determines whether device identification information recorded in the test zone matches that of the optical disk apparatus 1 (step ST34). If the recorded device identification information matches that of the optical disk apparatus 1 (YES in step ST34), the optical disk apparatus 1 determines the reliability of the recorded BCA data on the basis of a predetermined threshold value (step ST35). For example, the reliability is determined on the basis of the error rate of reproduced BCA data or the amount of jitter of a reproduced signal.

If it is determined that the BCA data recorded in the test zone is highly reliable (YES in step ST35), the optical disk apparatus 1 uses this BCA data to perform processing for copyright protection or the like.

On the other hand, if no BCA data is recorded in the test zone (NO in step ST33) or it is determined that recorded BCA data cannot be used (NO in step ST34 or NO in step ST35), the optical disk apparatus 1 accesses the BCA to read BCA data recorded therein and use the read BCA data.

As described above, the BCA is an area in which data is recorded in a different format from that of data recorded in other areas including the test zone. Therefore, access time (or seek time) required for accessing the BCA is longer than that required for accessing other areas. Also, the BCA requires rotation speed control of a different type from that of rotation speed control for other areas. Additionally, since a frequency band of recording signals in the BCA differs from that in other areas, it takes time, for example, for switching from one frequency band to another.

In the write learning method of the second embodiment, after accessing the BCA once to read BCA data therefrom and recording the read BCA data in the test zone, the optical disk apparatus 1 can use the BCA data by accessing the test zone. This can eliminate the need for additional access to the BCA and reduce processing time. Since BCA data is used for both data recording and reproduction, it is advantageous, in this respect also, to reduce processing time required for reading BCA data.

Moreover, since BCA data is recorded in the test zone, a write learning process can be performed as before using the BCA data without affecting the data recording area in which user data is recorded. Thus, the write learning method of the second embodiment can also achieve effective use of the test zone.

An HD DVD has an area called “system lead-in area” in which data, such as information about the type and format of the disk and production information about the disk, is recorded.

In the second embodiment described above, BCA data is recorded in the test zone of the optical disk 200. However, instead of BCA data, data recorded in the system lead-in area may be recorded in the test zone.

For example, a pitch between adjacent recording tracks in the system lead-in area is larger than that in the data recording area, and the length of recording marks in the system lead-in area is longer than that in the data recording area. Therefore, reproducing data from the system lead-in area involves, for example, switching from one frequency band to another. When data recorded in the system lead-in area is recorded in the test zone in which a pitch between adjacent recording tracks is the same as that in the data recording area, it is possible to reduce processing time required for frequency band switching and the like and thus to reduce initial time.

As described above, with the optical disk apparatus 1 and control method therefor according to the embodiments of the present invention, it is possible not only to reduce learning time required for determining optimum recording laser power and the like, but also to achieve effective use of a PCA on which test write is performed.

The present invention is not limited to the embodiments described above, and constituent elements may be modified and embodied without departing from the scope of the present invention in an implementation phase. Additionally, various embodiments of the invention can be made by appropriately combining a plurality of constituent elements disclosed in the embodiments described above. For example, some of the constituent elements disclosed in the embodiments may be omitted. Furthermore, constituent elements in the different embodiments may be appropriately combined with each other.

What is claimed is:

1. An optical disk apparatus for recording data on and reproducing data from a recordable optical disk, the optical disk apparatus comprising:
a storage unit configured to store specific useful information necessary for at least one of recording data on and reproducing data from the optical disk; and
a control unit configured to record the useful information stored in the storage unit in a test write area of the optical disk, and reproduce and use the recorded useful information when the optical disk is placed in the optical disk apparatus.

2. The optical disk apparatus according to claim 1, wherein the useful information stored in the storage unit includes a plurality of values of recording laser power for use in test write performed on the optical disk and device identification information of a device which performs test write;
the control unit is configured to record the plurality of values of recording laser power in a plurality of respective test write areas along with the device identification information;
the control unit is configured to reproduce data recorded in the plurality of test write areas when the optical disk is placed in the optical disk apparatus;
the control unit is configured to select, when the device identification information recorded in the test write areas matches device identification information of the optical disk apparatus, the best test write area from the plurality of test write areas on the basis of the quality of a reproduced signal; and
the control unit is configured to determine a value of recording laser power recorded in the selected best test write area to be an optimum laser power value.

3. The optical disk apparatus according to claim 1, wherein the useful information stored in the storage unit includes a plurality of pieces of recording strategy information and device identification information of a device which performs test write;
the control unit is configured to record the plurality of pieces of recording strategy information in a plurality of respective test write areas along with the device identification information;
the control unit is configured to reproduce data recorded in the plurality of test write areas when the optical disk is placed in the optical disk apparatus;
the control unit is configured to select, when the device identification information recorded in the test write areas matches device identification information of the optical disk apparatus, the best test write area from the plurality of test write areas on the basis of the quality of a reproduced signal; and
the control unit is configured to determine recording strategy information recorded in the selected best test write area to be optimum recording strategy information.

4. The optical disk apparatus according to claim 1, wherein the useful information stored in the storage unit includes BCA data recorded in a burst cutting area of the optical disk and device identification information of a device which performs test write using the BCA data;
the control unit is configured to record the BCA data in the test write area along with the device identification information;
the control unit is configured to reproduce data recorded in the test write area when the optical disk is placed in the optical disk apparatus; and
the control unit is configured to use, when the device identification information recorded in the test write area matches device identification information of the optical disk apparatus, the BCA data recorded in the test write area without accessing the burst cutting area of the optical disk.

5. The optical disk apparatus according to claim 1, wherein the useful information stored in the storage unit includes system lead-in data recorded in a system lead-in area of the optical disk and device identification information of a device which performs test write using the system lead-in data;
the control unit is configured to record the system lead-in data in the test write area along with the device identification information;
the control unit is configured to reproduce data recorded in the test write area when the optical disk is placed in the optical disk apparatus; and
the control unit is configured to use, when the device identification information recorded in the test write area matches device identification information of the optical disk apparatus, the system lead-in data recorded in the test write area without accessing the system lead-in area of the optical disk.

6. A control method for an optical disk apparatus for recording data on and reproducing data from a recordable optical disk, the control method comprising the steps of:
storing specific useful information necessary for at least one of recording data on and reproducing data from the optical disk;
recording the stored useful information in a test write area of the optical disk; and
reproducing and using the recorded useful information when the optical disk is placed in the optical disk apparatus.

7. The control method according to claim 6, wherein the useful information includes a plurality of values of recording laser power for use in test write performed on the optical disk and device identification information of a device which performs test write;
in the recording step, the plurality of values of recording laser power are recorded in a plurality of respective test write areas along with the device identification information;
in the reproducing and using step, data recorded in the plurality of test write areas is reproduced when the optical disk is placed in the optical disk apparatus;
the best test write area is selected, when the device identification information recorded in the test write areas matches device identification information of the optical disk apparatus, from the plurality of test write areas on the basis of the quality of a reproduced signal; and
a value of recording laser power recorded in the selected best test write area is determined to be an optimum laser power value.

8. The control method according to claim 6, wherein the useful information includes a plurality of pieces of recording strategy information and device identification information of a device which performs test write;
in the recording step, the plurality of pieces of recording strategy information are recorded in a plurality of respective test write areas along with the device identification information;
in the reproducing and using step, data recorded in the plurality of test write areas is reproduced when the optical disk is placed in the optical disk apparatus;
the best test write area is selected, when the device identification information recorded in the test write areas matches device identification information of the optical disk apparatus, from the plurality of test write areas on the basis of the quality of a reproduced signal; and
recording strategy information recorded in the selected best test write area is determined to be optimum recording strategy information.

9. The control method according to claim 6, wherein the useful information includes BCA data recorded in a burst cutting area of the optical disk and device identification information of a device which performs test write using the BCA data;
in the recording step, the BCA data is recorded in the test write area along with the device identification information;
in the reproducing and using step, data recorded in the test write area is reproduced when the optical disk is placed in the optical disk apparatus; and
when the device identification information recorded in the test write area matches device identification information of the optical disk apparatus, the BCA data recorded in the test write area is used without accessing the burst cutting area of the optical disk.

10. The control method according to claim 6, wherein the useful information includes system lead-in data recorded in a system lead-in area of the optical disk and device identification information of a device which performs test write using the system lead-in data;
in the recording step, the system lead-in data is recorded in the test write area along with the device identification information;
in the reproducing and using step, data recorded in the test write area is reproduced when the optical disk is placed in the optical disk apparatus; and
when the device identification information recorded in the test write area matches device identification information of the optical disk apparatus, the system lead-in data recorded in the test write area is used without accessing the system lead-in area of the optical disk.
